(19) United States
(12) Patent Application Publication
(10) Pub. No.: US 2017/0044972 A1
(43) Pub. Date: Feb. 16, 2017

(54) BEARING HOUSING BODY ASSEMBLY OF AN EXHAUST-GAS TURBOCHARGER

(71) Applicant: BorgWarner Inc., Auburn Hills, MI (US)

(72) Inventor: OLIVER SCHUMNIG, GUNDERSHEIM (DE)

(73) Assignee: BorgWarner Inc., Auburn Hills, MI (US)

(21) Appl. No.: 15/306,516

(22) PCT Filed: Apr. 20, 2015
(86) PCT No.: PCT/US15/26598

§ 371 Date: Oct. 25, 2016

(30) Foreign Application Priority Data
Apr. 29, 2014 (DE) 102014208067.3

(51) Int. Cl. F02B 39/14; F16C 33/10; F16C 17/10; F01D 25/16; F01D 25/18

(52) U.S. Cl. CPC F02B 39/14; F01D 25/166; F01D 25/18; F16C 17/10; F16C 33/1045; F16C 33/103; F05D 2220/40; F16C 2360/24

(57) ABSTRACT

The invention relates to a bearing housing body assembly (1) of an exhaust-gas turbocharger, having a housing (2) for a bearing arrangement (8, 9) of a rotor shaft (3); having a turbine wheel (4) on one end (5) of the rotor shaft (3); and having a compressor wheel (6) on the opposite end (7) of the rotor shaft (3), wherein an oil reservoir (10, 11) is formed in the housing (2) adjacent to the bearing arrangement (8, 9).

The invention relates to a bearing housing body assembly of an exhaust-gas turbocharger, as per the preamble of claim 1.

At present, bearing housing body assemblies of said type are very much susceptible to wear, to the point of bearing failure. Specifically at low temperatures, for example of below −25° C., it takes a very long time for the viscous lubricating oil to arrive at the bearing points through the thin bores. Since performance cannot be withheld for such a long period of time, increased wear can occur, to the point of damage of the bearing arrangement.

It is therefore an object of the present invention to provide a bearing housing body assembly of an exhaust-gas turbocharger as per the preamble of claim 1 which permits improved lubrication of the bearing points in the event of a cold start.

This object is achieved by the features of claim 1.

By contrast to known bearing housing body assemblies, in which the lubrication of the bearing points is realized via a multiplicity of oil ducts or bores in the housing, the formation, according to the invention, of an oil reservoir arranged in the housing of the exhaust-gas turbocharger yields the advantage that, during the starting or during a cold start of the internal combustion engine, it is possible to realize a significantly improved oil supply to the bearing points, and a fundamentally reduced susceptibility of the bearing arrangements to wear before a build-up of oil occurs. Thus, said advantages are attained in particular when the body assembly according to the invention is used in turbochargers which are used on engines with start-stop functions.

The dependent claims contain advantageous developments of the invention.

In a particularly preferred embodiment, the oil reservoir of the bearing housing body assembly according to the invention may be arranged below the rotor shaft. It is thus possible for the oil to pass easily into the oil reservoir under the force of gravity.

The oil reservoir may preferably have a first oil pocket and a second oil pocket which are formed in the housing. In this way, the oil reservoir can be created by removal of material in the housing, rather than using an additional component, which would lead to an increase in weight of the exhaust-gas turbocharger.

In this case, it is furthermore preferable for the first oil pocket and the second oil pocket to be annular grooves, which are easy to produce. Furthermore, the grooves, the shape of which corresponds to the external contour of the bearing bushings and which can surround the bearing bushings, offer the advantage of an improved flow of oil into the oil reservoir. Furthermore, annular grooves are advantageous for acoustic reasons. Sickle-shaped grooves, which in the installed state of the charger are situated above the shaft, are duly known. These however serve only for the supply of oil, but cannot be used as an oil reservoir in accordance with the principles of the present invention, as they are not capable, owing to their design and arrangement, of storing oil.

It is furthermore preferable for the bearing arrangement to have a first bearing bushing and a second bearing bushing, which can be supplied with oil from the first oil pocket and from the second oil pocket. It is thus possible for the radial and axial forces generated during the operation of the exhaust-gas turbocharger to be absorbed in a more reliable manner by the first bearing bushing and by the second bearing bushing.

For acoustic reasons, it is preferably possible for the first bearing bushing and the second bearing bushing to each be equipped with an annular groove which is formed on the outer surface of the bearing bushings. It should be noted that the acoustic effects attained by way of the oil pockets in the form of annular grooves, as already mentioned above, are enhanced through the provision of an annular groove in the bearing bushings. Furthermore, the annular grooves can, if they are arranged concentrically with respect to the oil pockets, increase the available space in the oil reservoir. It is thus possible for the oil reservoir to retain a greater amount of oil that can be made available upon starting until the normal circulation of oil commences. Furthermore, the design of the oil reservoir according to the invention can be implemented in existing turbochargers which have bearing bushings with an annular groove. In this case, it must be ensured that an adequate bearing width is provided.

It is furthermore advantageous if the bearing housing body assembly comprises a compressor wheel-side housing cover which can be fixed in a compressor wheel-side housing opening by means of a fastening device.

Further details, advantages and features of the present invention can be found in the following description of exemplary embodiments with reference to the drawing, in which:

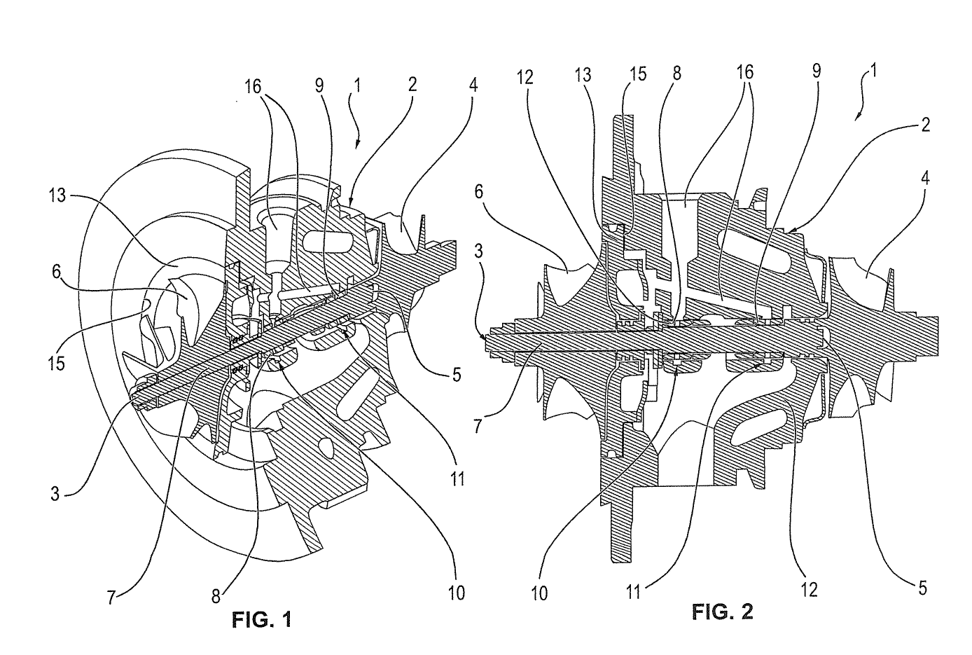

FIG. 1 shows a perspective, partially sectional illustration of an embodiment of a bearing housing body assembly according to the invention; and

FIG. 2 shows a longitudinal section through the bearing housing body assembly as per FIG. 1.

FIGS. 1 and 2 illustrate a bearing housing body assembly 1 of an exhaust-gas turbocharger. The body assembly 1 has a housing 2 for a bearing arrangement 8, 9 of a rotor shaft 3.

Furthermore, the body assembly 1 comprises a turbine wheel 4 on one end 5 of the rotor shaft 3, whereas a compressor wheel 6 is arranged on the opposite end 7 of the rotor shaft 3.

The bearing arrangement has a first bearing bushing 8 and a second bearing bushing 9, for example a radial bearing bushing and an axial bearing bushing.

An oil reservoir 10, 11 is formed in the housing 2 adjacent to the bearing arrangement 8, 9. In particular, the oil reservoir 10, 11 is arranged below the rotor shaft 3 when the body assembly 1 is in the installed state.

Furthermore, in the illustrated example, the oil reservoir has a first oil pocket 10 and a second oil pocket 11 which are formed in the housing 2. In this embodiment of the present invention, the first oil pocket 10 and the second oil pocket 11 are in the form of annular grooves.

Furthermore, the housing 2 has oil feed bores 16 via which the first bearing bushing 8 and the second bearing bushing 9 are lubricated during normal operation of the exhaust-gas turbocharger.

At the compressor side, the housing cover 13 can be fixed in a compressor wheel-side housing opening 15 by means of a fastening device 14.

The integration of the oil pockets 10, 11 in the housing 2 provides a space which permanently retains oil even when the internal combustion engine is shut down when the oil is at operating temperature.

The highly viscous oil which is situated in the oil pockets 10, 11 upon a cold start can then immediately lubricate the bearing bushings 8, 9. Friction causes the space around the bearing bushings 8, 9, and also the small oil sump of the oil pockets 10, 11, to warm up quickly. As a result, the oil can be distributed to an ever-improving extent over the bearing bushings 8, 9 and lubricate these until new oil flows in via the oil feed bores 16. Wear or premature failure of the bearing bushings 8, 9 can thus be decisively counteracted.

Furthermore, the oil pockets 10,11 according to the invention do not exhibit an increased risk with regard to potential coking. It should be noted that more thinly oil-wetted component surfaces exhibit greater potential for oil coking. Furthermore, the first oil pocket 10 and the second oil pocket 11 are flushed through with new fresh oil every time.

It should also be noted that, in the case of the present invention, any other suitable lubricant is likewise conceivable instead of oil.

In addition to the above written description of the invention, reference is hereby explicitly made, for additional disclosure thereof, to the diagrammatic illustration of the invention in FIGS. 1 to 2.

### LIST OF REFERENCE SIGNS

1 Bearing housing body assembly
2 Housing
3 Rotor shaft
4 Turbine wheel
5 First end of the rotor shaft 3
6 Compressor wheel
7 Second, opposite end of the rotor shaft 3
8 Bearing arrangement/first bearing bushing
9 Bearing arrangement/second bearing bushing
10 Oil reservoir/first oil pocket
11 Oil reservoir/second oil pocket
12 Annular groove
13 Housing cover
14 Fastening device
15 Housing opening
16 Oil feed bores

1. A bearing housing body assembly of an exhaust-gas turbocharger,
having a housing for a bearing arrangement of a rotor shaft;
having a turbine wheel on one end of the rotor shaft; and
having a compressor wheel on the opposite end of the rotor shaft,
characterized
in that an oil reservoir is formed in the housing adjacent to the bearing arrangement.

2. The bearing housing body assembly as claimed in claim 1, characterized in that the oil reservoir is arranged below the rotor shaft.

3. The bearing housing body assembly as claimed in claim 1, characterized in that the oil reservoir has a first oil pocket and a second oil pocket which are formed in the housing.

4. The bearing housing body assembly as claimed in claim 3, characterized in that the first oil pocket and the second oil pocket are annular grooves.

5. The bearing housing body assembly as claimed in claim 1, characterized in that the bearing arrangement has a first bearing bushing and a second bearing bushing.

6. The bearing housing body assembly as claimed in claim 5, characterized in that the first bearing bushing and the second bearing bushing are each equipped with an annular groove which is formed on the outer surface of the bearing bushings.

7. The bearing housing body assembly as claimed in claim 1, characterized by a compressor wheel-side housing cover which can be fixed in a compressor wheel-side housing opening by means of a fastening device.
